(19) United States
(12) Patent Application Publication
(10) Pub. No.: US 2009/0025164 A1
(43) Pub. Date: Jan. 29, 2009

(54) Washing wand with rotating cleaning head

(76) Inventor: Sun Y. Kim, Hayward, CA (US)

Correspondence Address: RICHARD ESTY PETERSON, Patent Attorney, Suite D, 1905 Palmetto Avenue, Pacifica, CA, 94044, US

(21) Appl. No.: 11/881,520

(22) Filed: Jul. 27, 2007

(51) Int. Cl. B25G 1/04; B25G 1/00

(52) U.S. Cl. 15/144.1; 15/143.1

(57) ABSTRACT

A rotary washing wand that is connectable to a conventional garden hose, the wand including an elongated tube having a handle portion with a hose connector and a flow control valve and a distal end with a cleaning head having a housing containing a nozzle at the end of the elongated tube and a water wheel on a shaft with one end that extends through the housing and is joined to a rotatable washing implement, such as a sponge with the cleaning head having a shroud around the washing implement to direct water at the object being washed.

### BACKGROUND OF THE INVENTION

This invention relates to a washing wand and in particular to a washing wand having a rotatable cleaning head having a water driven washing disk. The rotatable washing disk is preferably provided with a circular brush or sponge pad to facilitate cleaning.

Many common cleaning tasks can be assisted by the use of a brush or sponge that is attached to an elongated handle. For example, in washing a car or cleaning outside windows, an elongated handle will enable cleaning of places that are typically hard to reach. In such situations, the ability to add soap and water to the cleaning member will both save time and improve the cleaning process. Additionally, when the cleaning member is rotated, the cleaning process is greatly accelerated.

### SUMMARY OF THE INVENTION

The washing wand of this invention is designed particularly for use with a common garden hose. The garden hose attaches to the end of a hollow rigid tube with a handle portion near the end attached to the garden hose. The rigid tube has a distal end with a cleaning head that is rotatably mounted to a turbine mechanism having a housing attached to the rigid tube. The turbine mechanism includes a water wheel with a shaft rotatably mounted in bearings in the housing. The water wheel has a series of vanes that drive the water wheel on contact by water discharged into the housing through the tube. The discharge end of the tube includes a nozzle to accelerate the water flow directed at the vanes. The water wheel shaft projects from one side of the housing and has a connector for the cleaning head which may be fixed to the shaft or removable. Preferably, the cleaning head is removable and can be replaced with like or different accessories. For example, the cleaning head may be constructed with a scrubbing implement such as a circular brush or sponges of different textures and configurations.

In the preferred embodiment, the housing includes water discharge openings directed at the scrubbing implement and a skirt to shield the spent water around the cleaning head. Other features, including a water control valve and a soap dispenser to respectively control the water flow and add a liquid soap to the water stream, improves the utility of the washing wand for a variety of cleaning tasks.

### BRIEF DESCRIPTION OF THE DRAWINGS

FIG. 1 is a side view, partially broken away, showing the rotary washing wand with an attached sponge.

FIG. 2 is an enlarged partial cross sectional view of the cleaning head of the washing wand of FIG. 1 taken on the lines 2-2 in FIG. 1.

FIG. 3 is a side elevational view of a circular brush attachment for the washing wand of FIG. 1.

FIG. 4 is a partial side elevational view of an extension attachment for the washing wand of FIG. 1.

### DETAILED DESCRIPTION OF THE PREFERRED EMBODIMENTS

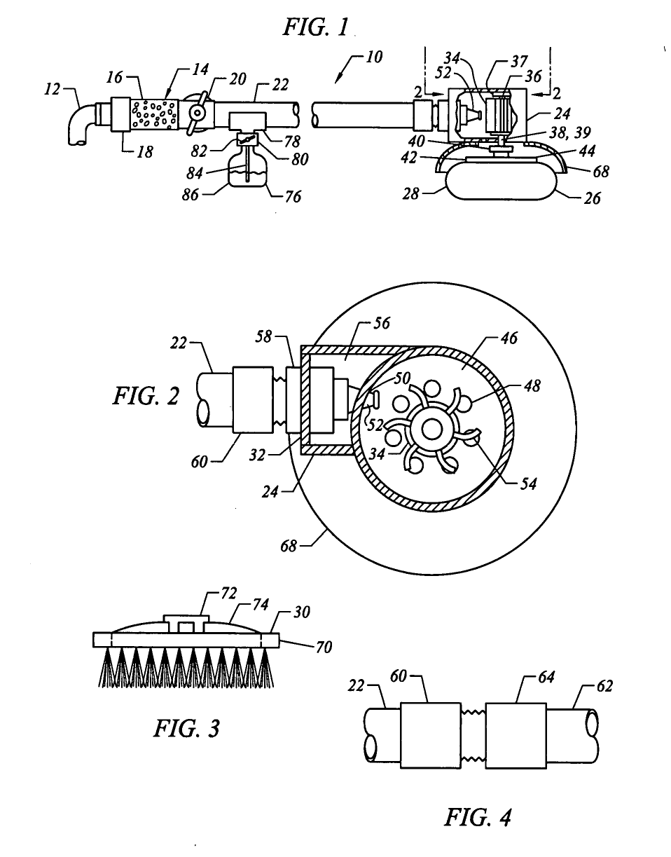

Referring to FIG. 1, the rotary washing wand is designated generally by the reference numeral 10 and is shown connected to a conventional garden hose 12. The washing wand 10 has a handle portion 14 that includes a cushioned handgrip 16 between a hose connector 18 at the end and a stop cock valve 20 displaced from the end and oriented for convenient operation to adjust the water flow. The washing wand 10 has an elongated tube 22 connected to, and extending from, the valve 20. At the distal end of the elongated tube is a cleaning head 24 with a scrubbing implement 26 in the form of a sponge 28. The scrubbing implement 26 is preferably detachable to allow replacement with an identical implement or a different implement, such as a circular brush 30 as shown in FIG. 3, or a sponge of different configuration or texture.

The cleaning head 24 has a housing 32 that contains a rotatable water wheel 34 carried on a shaft 36 that seats in a socket bearing 37 at one end and projects through a journal bearing 38 and hole 39 in the housing 32 at the other end to connect to a connector 40 on a disk assembly 42. The disk assembly 42 includes a supporting but flexible disk 44 to which the sponge 28 is secured, for example, by an adhesive. The connector 40 and shaft end are threaded to allow detachment and replacement of the scrubbing implement 26 with like or different implements as noted.

The housing 32 has a main chamber 46 having a series of water discharge holes 48 and an aperture 50 into which a nozzle 52 is inserted and sealed to direct a high velocity water flow at a series of curved vanes 54 on the water wheel 34. The nozzle 52 projects into the chamber 46 from an antechamber 56 where a connector fitting 58 for the nozzle 52 provides a mount to connect the cleaning head 24 to the end of the elongated tube 22. The end of the tube 22 has a threaded male connection fitting 60 that connects to the threaded female connector fitting 58 fixed to the housing 32.

As shown in FIG. 4, this simple connecting scheme is useful for adding an extension tube 62 having a similar female connector fitting 64 that connects to the male connector fitting 60 at the end of the hand-held tube 22. A similar male connector fitting (not shown) at the distal end of the extension tube 62 permits connection of the cleaning head 24 in the same manner. The extension tube 62 may be selected for the task contemplated and may be short with a bend for cleaning floors and pavement or elongated for cleaning hard to reach windows.

In order to direct the discharging water to the scrubbing implement 26, a flexible shield or shroud 68 extends from the housing 32 and encompasses the sponge 28 or brush 30. As shown in FIG. 3, the brush 30 has a circular brush ring 70 that is joined to the threaded hub 72 by spokes 74 to allow water to pass to the center of the brush ring 70 during operation.

In addition, the rotatable washing wand of this invention includes a soap dispenser 76 connected to the elongated tube 22 by a saddle fitting 78 with a threaded cap 80 having a turnkey valve 82 that controls the siphoning action of a draw tube 84 that extracts liquid soap from the refillable dispenser bottle 86. During operation, the user can activate the soap dispensing valve 82 and dispense soap into the water stream at the rate desired.

Wherein the foregoing embodiments of the present invention have been set forth in considerable detail for the purposes of making a complete disclosure of the invention, it may be apparent to those of skill in the art that numerous changes may be made in such detail without departing from the spirit and principles of the invention.

1. A rotary washing wand connectable to a conventional garden hose, comprising:
an elongated tube having a first end with a hose connector and a handle and a second distal end having a cleaning head wherein the first end with the handle has a flow control valve for regulating water flow through the elongated tube and the cleaning head has a housing with a nozzle at the end of the elongated tube and a water wheel contained in the housing wherein the housing forms a chamber with the nozzle projecting into the chamber and wherein the nozzle is directed at the water wheel and the water wheel is rotatably supported in the housing, the housing having a bottom with a shaft having a portion of the shaft projecting from the bottom of the housing, the cleaning head further having a rotatable washing implement connected to the portion of the shaft projecting from the housing, the bottom of the housing having a series of holes around the portion of the shaft projecting from the housing, the holes directing water discharged into the housing to the washing implement wherein the cleaning head has a shroud mounted on the bottom of the housing around the series of holes and extending down around the outside perimeter of the washing implement for directing water at the washing implement and to the object that is washed.

2. The rotary washing wand of claim 1 wherein the washing wand further comprises an extension tube having ends with a connector at one end connectable to the distal end of the elongated tube and a connector at the other end connectable to the cleaning head.

3. The rotary washing wand of claim 1 wherein the elongated tube has a soap dispenser near the handle with a valve for controlled dispensing of soap into the water stream when washing.
